(19) United States
(12) Patent Application Publication
(10) Pub. No.: US 2012/0269260 A1
(43) Pub. Date: Oct. 25, 2012

(54) METHOD FOR CODING A SEQUENCE OF IMAGES

(76) Inventors: Xavier Ducloux, Rennes (FR); Alain Sorin, Sesson-Sevigne (FR); Yannick Olivier, Thorigne Fouillard (FR); Bruno Guesdon, Rennes (FR)

(21) Appl. No.: 13/392,644

(22) PCT Filed: Aug. 17, 2010
(86) PCT No.: PCT/EP10/61980

§ 371 Date: Jul. 13, 2012

(30) Foreign Application Priority Data
Aug. 28, 2009 (FR) 0955871

(51) Int. Cl. H04N 7/30

(52) U.S. Cl. 375/240.2; 375/240.18; 375/E07.226

(57) ABSTRACT

The invention relates to a method for coding a sequence of images divided into blocks, comprising the following steps for a current block:—selecting, for the current block, a coding mode in a set of coding modes that comprises at least two coding modes, and a transform in a set of transforms that comprises at least a first transform and a second transform; and—coding the current block according to the coding mode and the transform selected. The coding mode and the transform, themselves, are selected according to the following steps:—selecting the coding mode in the set of coding modes while using the first transform, and—selecting the transform in the set of transforms while using the coding mode selected.

### 1. SCOPE OF THE INVENTION

The invention relates to the general field of coding a sequence of images. More specifically, the invention relates to a method for coding a sequence of images divided into blocks.

### 2. PRIOR ART

In reference to FIG. 1, a method is known for coding a current block Bc of an image comprising a step 10 of selection of coding parameters (for example a coding mode) and a step 12 of coding of the current block Bc in a stream of coded data F using coding parameters selected in step 10. In reference to FIG. 2, the coding step generally comprises the transformation 120 via a transform of the current block Bc into a transformed block, the quantization 122 of the transformed block into a quantized block and the effective coding 124 of the quantized block into the stream of coded data F. According to a variant, the coding step 12 comprises prior to the step of transformation 120, a step of prediction of the current block Bc according to a coding mode Mc using image data previously coded and reconstructed that belongs either to the same image as the current block Bc (spatial prediction or INTRA) or to one or several different images (temporal prediction or INTER). The step of transformation 120 is then applied on the residual block obtained by subtracting pixel by pixel the prediction block from the current block Bc. In the scope of the H.264 coding standard as defined in section 8.5 of the document ISO/IEC 14496-10 Second Edition entitled “Information Technology—Coding of audio-visual objects—Part 10: Advanced Video Coding” published Dec. 15, 2005, several transforms can be used during the transformation 120 of the current block Bc or of the corresponding residual block. In this case, the step of selection 10 of coding parameters comprises the selection for the current block Bc of a coding mode Mc in a set of coding modes and of a transform Tc in a set of transforms. According to a method known in the prior art, the coding modes of the set of coding modes and the transforms of the set of transforms are exhaustively tested to determine the coding mode/transform pair that offers the best compromise in terms of bitrate-distortion for the coding of the current block Bc. More specifically, the current block Bc or the corresponding residual block is successively coded with each possible pair of coding mode and transform, then reconstructed.

From the reconstructed block Bc and the original block Bc a distortion is calculated and the number of bits required for the coding of the current block

Bc or the corresponding residual block is also determined. Hence, for each coding mode and transform pair, a distortion weighted by a coding cost is calculated. The pair (coding mode, transform) that results in the lowest weighted distortion is selected. This selection method is very costly in terms of calculation cost as it implies coding then reconstructing the current block or the corresponding residual block numerous times. For example, in reference to FIG. 3, the coding mode set comprises 7 coding modes (M1 to M7) and the transform set comprises two transforms (T1 and T2). During the step 10 of selection of coding parameters, 14 coding/reconstruction operations of the current block Bc or the corresponding residual block are carried out with a view to selecting the optimal pair (Mc,Tc) from the bitrate-distortion perspective, i.e. enabling the best bitrate-distortion compromise.

### 3. SUMMARY OF THE INVENTION

The purpose of the invention is to overcome at least one of the disadvantages of the prior art. For this purpose, the invention relates to a method for coding a sequence of images divided into blocks comprising the following steps for a current block:
selecting, for the current block, a coding mode in a set of coding modes comprising at least two coding modes and a transform in a set of transforms comprising at least a first transform and a second transform, and
coding the current block according to the coding mode and the transform selected.

According to the invention, the coding mode and the transform are selected according to the following steps:
selecting the coding mode in the set of coding modes while using the first transform, and
selecting the transform in the set of transforms while using the coding mode selected.
   The method for coding according to the invention advantageously enables the number of coding/reconstruction operations to be reduced.

According to a particular aspect of the invention, with some coding modes of the set of coding modes, the use of the first transform in not authorized and during the step of selection of the coding mode in the set of coding modes, the second transform is used for these coding modes instead of the first transform.

According to a particular characteristic of the invention, the first transform is an integer DCT transform of size 4×4 and the second transform is an integer DCT transform of size 8×8.

Advantageously, the coding mode is selected in the set of at least two coding modes according to the following steps:
calculating, for each of the coding modes of the set of coding modes, a distortion between the current block and the current block reconstructed after its coding according to the coding mode while using the first transform,
calculating, for each of the coding modes of the set, a coding cost of the current block coded according to the coding mode while using the first transform,
calculating, for each of the coding modes of the set, a weighted sum of the distortion and the coding cost, and
selecting, in the set of coding modes, the coding mode for which the weighted sum is lowest.

Advantageously, the transform is selected in the set of transforms according to the following steps:
calculating for each of the transforms of the set of transforms a distortion between the current block and the current block reconstructed after its coding according to the coding mode selected,
calculating for each of the transforms of the set of transforms a coding cost of the current block coded according to the coding mode selected,
calculating for each of the transforms of the set of transforms a weighted sum of the distortion and the coding cost, and
selecting in the set of transforms the transform for which the weighted sum is lowest.

### 4. LIST OF FIGURES

The invention will be better understood and illustrated by means of embodiments and advantageous implementations, by no means limiting, with reference to the figures in the appendix, wherein:

FIG. 1 shows a coding method according to the prior art,

FIG. 2 shows a first step of the coding method according to the prior art,

FIG. 3 shows a second step of the coding method according to the prior art,

FIG. 4 shows a coding method according to the invention,

FIG. 5 shows two steps of the coding method according to the invention,

FIG. 6 shows a variant of two steps of the coding method according to the invention shown in FIG. 5, and

FIG. 7 shows a coding device according to the invention.

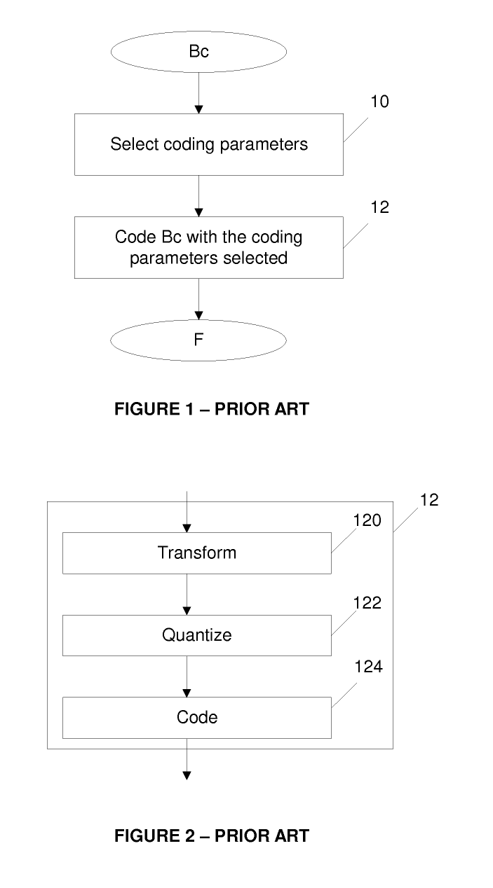

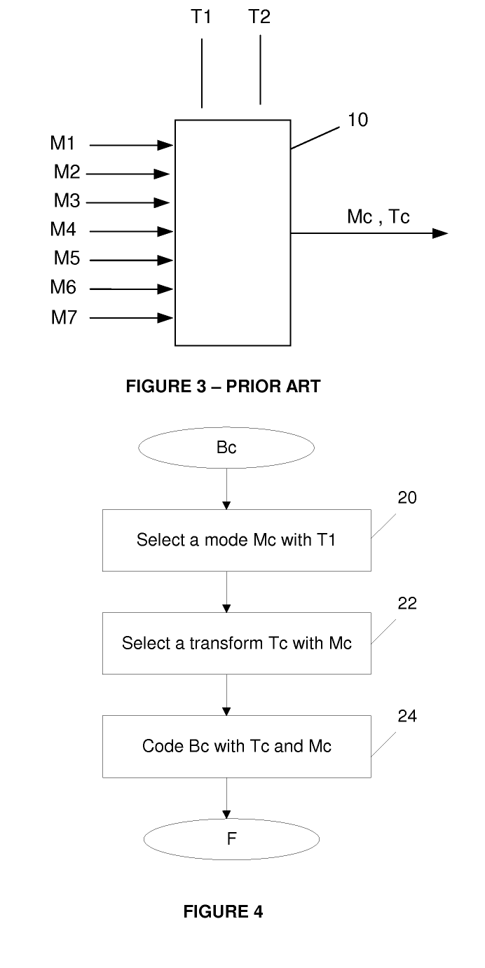

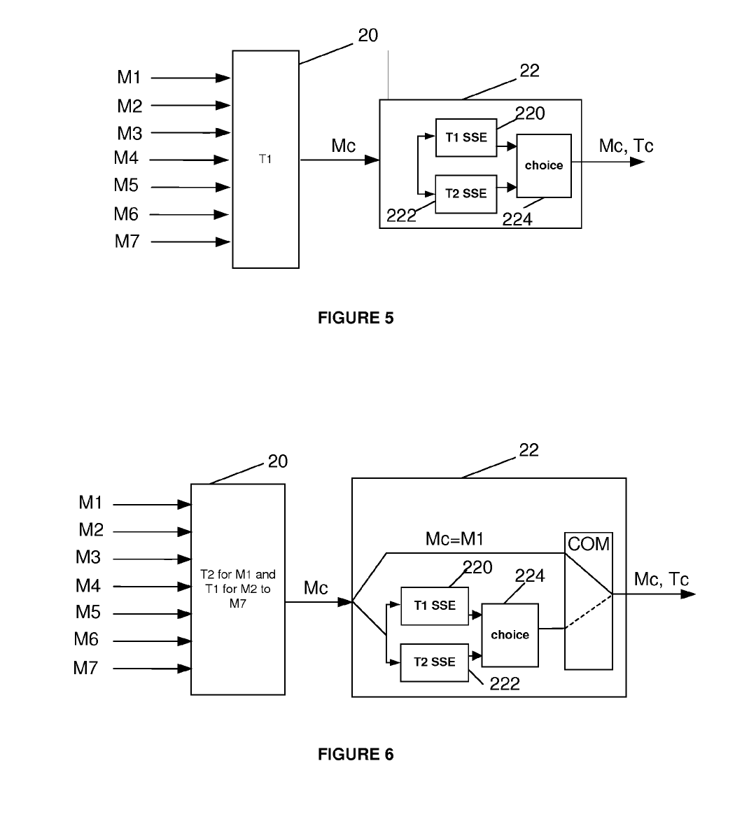

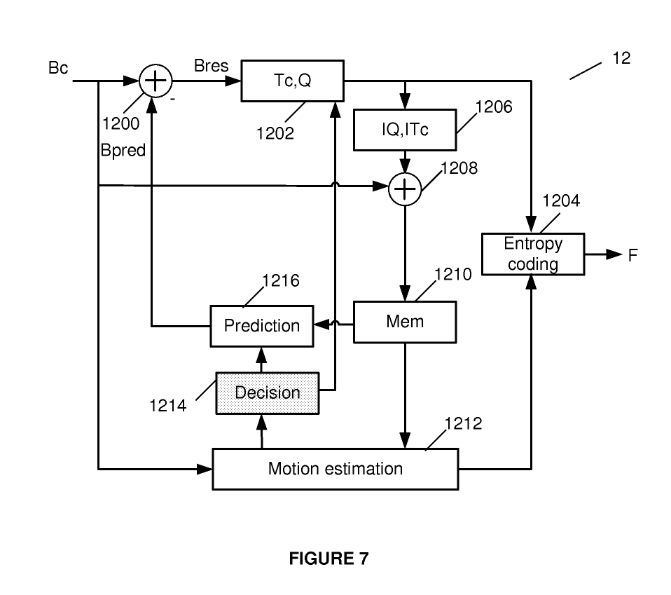

### 5. DETAILED DESCRIPTION OF THE INVENTION

The invention relates to a method for coding a sequence of images in the form of a stream of coded data F. A sequence of image is a series of several images. Each image comprises pixels or image points with each of which is associated at least one item of image data. An item of image data is for example an item of luminance data or an item of chrominance data.

A coding mode specifies the way in which the block is coded. Generally, the coding mode specifies if the block is coded in INTRA or INTER mode. Then, if the current block Bc is coded in INTRA mode, the coding mode can specify if the current block Bc is predicted spatially or not. If it is predicted spatially, the coding mode specifies the way in which it is predicted. For example, in the case of the H.264 standard, 3 INTRA modes are defined: the 8×8 INTRA mode, the 16×16 INTRA mode and the 4×4 INTRA mode.

If the current block Bc is coded in INTER mode, the coding mode can possibly specify the way in which the current block Bc is partitioned. For example, in the case of the H.264 standard, 4 INTER modes are defined in relation with the partitioning of a block into sub-blocks: the 16×16 INTER mode, the 16×8 INTER mode, the 8×16 INTER mode and the 8×8 INTER mode.

The distortion of a current block Bc of size N pixels by N pixels is generally calculated between the original current block Bc and the coded then reconstructed current block Bc noted as nverse operation of module 1202.

The module 1206 carries out an inverse quantization IQ followed by an inverse transform ITc. The module 1206 is connected to a calculation module 1208 able to merge, for example by addition pixel by pixel, the block of data from the module 1206 and the prediction block Bpred to generate a block of reconstructed image data that is stored in a memory 1210. The coding device 12 also comprises a motion estimation module 1212 able to estimate at least one motion vector between the block Bc and a block of a reference image Ir stored in the memory 1210, this image having been previously coded then reconstructed. According to a variant, the motion estimation can be carried out between the current block Bc and the original reference image Ic in which case the memory 1210 is not connected to the motion estimation module 1212. According to a method well known to those skilled in the art, the motion estimation module searches the reference image Ir for an item of motion data, notably a motion vector in such a manner as to minimize an error calculated between the current block Bc and a block in the reference image Ir identified by means of the item of motion data.

The motion data determined are transmitted by the motion estimation module 1212 to a decision module 1214 able to select a coding mode for the block Bc in a set of coding modes and a transform Tc in a set of transforms. The decision module is adapted to implement steps 20 and 22 of the coding method according to the invention. The coding mode Mc selected is for example that which minimizes a bitrate-distortion type criterion. However, the invention is not restricted to this selection method and the mode retained can be selected according to another criterion for example an a priori type criterion. The coding mode selected by the decision module 1214 as well as the motion data, for example the item or items of motion data in the case of the temporal prediction mode or INTER mode are transmitted to a prediction module 1216. The coding mode selected and in the contrary case the item or items of motion data are also transmitted to the entropy coding module 1204 to be coded in the Stream F. The prediction module 1216 determines the prediction block Bpred from the coding mode determined by the decision module 1214 and possibly from motion data determined by the motion estimation module 1212 (inter-images prediction).

Naturally, the invention is not limited to the embodiment examples mentioned above.

In particular, those skilled in the art may apply any variant to the stated embodiments and combine them to benefit from their various advantages. In particular, the invention applies to any type of coding mode (INTER, INTRA, 20 mono-directional, bi-directional, etc.) and to any type of transform (DCT, integer DCT, Hadamard, wavelets, etc.). Moreover, the invention is in no way limited by the type of distortion used (for example SSE, SAD, etc.). The invention applies whatever the number of coding modes in the set of coding modes as long as it comprises at least two. Likewise, it applies whatever the 25 number of transforms in the set of transforms as long as it comprises at least two.

The invention is in no way limited by the criterion used to select the coding mode Mc and the transform Tc. Other criteria than those described may be used.

1. Method for coding a sequence of images divided into blocks comprising the following steps for a current block:
selecting for said current block, a coding mode in a set of coding modes comprising at least two coding modes and a transform in a set of transforms comprising at least a first transform and a second transform, and
coding said current block according to said coding mode and said transform selected,
said coding mode and said transform are selected according to the following steps:
selecting said coding mode in said set of coding modes while using said first transform, and
selecting said transform in said set of transforms while using said coding mode selected.

2. Method for coding according to claim 1, wherein with some coding modes of said set of coding modes, the use of said first transform is not authorized and in which during the step of selection of said coding mode in said set of coding modes, said second transform is used for said some coding modes instead of said first transform.

3. Method for coding according to claim 2, wherein said first transform is an integer DCT transform of size 4×4 and said second transform is an integer DCT transform of size 8×8.

4. Method for coding a sequence of images divided into blocks comprising the following steps for a current block:
selecting, for said current block, a coding mode in a set of coding modes comprising at least two coding modes and a transform in a set of transforms comprising at least a first transform and a second transform, and
coding said current block according to said coding mode and said transform selected, said coding mode and said transform being selected according to the following steps:
selecting said coding mode in said set of coding modes while using said first transform, and
selecting said transform in said set of transforms while using said coding mode selected,
wherein said coding mode is selected in said set of at least two coding modes according to the following steps:
calculating, for each of the coding modes of said set, of coding modes a distortion between said current block and said current block reconstructed after its coding according to said coding mode while using said first transform,
calculating, for each of the coding modes of said set, a coding cost of said current block coded according to said coding mode while using said first transform,
calculating, for each of the coding modes of said set, a weighted sum of said distortion and said coding cost, and
selecting, in said set of coding modes, the coding mode for which the weighted sum is lowest.

5. Method for coding a sequence of images divided into blocks comprising the following steps for a current block:
selecting, for said current block, a coding mode in a set of coding modes comprising at least two coding modes and a transform in a set of transforms comprising at least a first transform and a second transform, and
coding said current block according to said coding mode and said transform selected, said coding mode and said transform being selected according to the following steps:
selecting said transform in said set of coding modes while using said first transform, and
selecting said transform in said set of transforms while using said coding mode selected,
wherein said transform is selected in said set of transforms according to the following steps:
calculating for each of the transforms of said set of transforms a distortion 15 between said current block and said current block reconstructed after its coding according to said coding mode selected,
calculating for each of the transforms of said set of transforms a coding cost of said current block coded according to said coding mode selected,
calculating for each of the coding modes of said set of transforms a weighted sum of said distortion and said coding cost, and
selecting in said set of transforms the transform for which the weighted sum is lowest.

6. Method for coding according to claim 4, wherein with some coding modes of said set of coding modes, the use of said first transform is not authorized and in which during the step of selection of said coding mode in said set of coding modes, said second transform is used for said some coding modes instead of said first transform.

7. Method for coding according to claim 6, wherein said first transform is an integer DCT transform of size 4×4 and said second transform is an integer DCT transform of size 8×8.

8. Method for coding according to claim 5, wherein with some coding modes of said set of coding modes, the use of said first transform is not authorized and in which during the step of selection of said coding mode in said set of coding modes, said second transform is used for said some coding modes instead of said first transform.

9. Method for coding according to claim 5, wherein said first transform is an integer DCT transform of size 4×4 and said second transform is an integer DCT transform of size 8×8.

10. Method for coding according to claim 5, wherein said coding mode is selected in said set of at least two coding modes according to the following steps:
calculating, for each of the coding modes of said set, of coding modes a distortion between said current block and said current block reconstructed after its coding according to said coding mode while using said first transform,
calculating, for each of the coding modes of said set, a coding cost of said current block coded according to said coding mode while using said first transform,
calculating, for each of the coding modes of said set, a weighted sum of said distortion and said coding cost, and
selecting, in said set of coding modes, the coding mode for which the weighted sum is lowest.
